(19) United States
(12) Patent Application Publication
(10) Pub. No.: US 2025/0068532 A1
(43) Pub. Date: Feb. 27, 2025

(54) SYSTEM AND METHOD FOR AUTOMATED ANALYSIS AND UPGRADE FOR PROVISIONING A SET OF CLOUD REGIONS

(71) Applicant: Workspot, Inc., Campbell, CA (US)

(72) Inventors: Tarun Pandit, Fremont, CA (US); Anushree Kunal Pole, Sunnyvale, CA (US); Jimmy Chang, Mountain View, CA (US); Amitabh Bhuvangyan Sinha, San Jose, CA (US); Virabrahma Prasad Krothapalli, San Jose, CA (US); David T. Sulcer, Pacifica, CA (US)

(21) Appl. No.: 18/599,030

(22) Filed: Mar. 7, 2024

Related U.S. Application Data
(60) Provisional application No. 63/578,599, filed on Aug. 24, 2023.

(51) Int. Cl. G06F 11/30; G06F 11/34; H04W 4/02

(52) U.S. Cl. CPC G06F 11/301; G06F 11/3428; H04W 4/025

(57) ABSTRACT

A system and method for selecting Cloud regions for supporting a virtual desktop on a client device is disclosed. The system includes a plurality of available Cloud regions that each include resources for providing a virtual desktop to a client device of a user via a network. A monitoring service is coupled to the available cloud regions. The monitoring service collects use data from the available cloud regions in relation to providing virtual desktops to other client devices. A resource management engine is coupled to the available cloud regions. The resource management engine determines a score for each of a plurality of sets of the Cloud regions in relation to the client device. A control plane selects a set of Cloud regions from the plurality of sets according to the determined scores of each of the sets to provide the virtual desktop to the client device.

### PRIORITY CLAIM

This application claims priority to U.S. Provisional Application No. 63/578,599 filed on Aug. 24, 2023. The entirety of that application is hereby incorporated by reference.

### TECHNICAL FIELD

The present disclosure relates generally to network-based virtual desktop systems. More particularly, aspects of this disclosure relate to a system that automatically provisions regional cloud resources for a set of Cloud regions to support a virtual desktop for a particular client device.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into a computer workstation or client device and are provided a desktop application that displays an interface of applications and data available via the network or cloud. Such desktop applications will be initially accessed when a user logs in, but may remain active to respond to user operation of applications displayed on the desktop interface. While users may activate the desktop application on any computer on the network, most users work from one specific computer.

Cloud-based remote desktop virtualization solutions have been available for over a decade. These solutions provide virtual desktops to network users with access to public and/or private clouds. In cloud-based remote desktop virtualization offerings, there is typically a capability of associating a remote desktop virtualization template in a particular cloud region with a remote desktop virtualization pool in the same cloud region as part of the general configuration model. This remote desktop virtualization template is customized with the image of the right desktop for a particular remote desktop virtualization use case.

Cloud desktop service systems rely on “Cloud regions,” which may be defined as datacenters managed by and made accessible by public cloud service providers, or as part of privately-managed clouds not available to the public. Cloud regions are capable of hosting cloud desktops in a datacenter. Cloud desktops include full desktop experiences as well as remotely hosted virtual applications that are available over computer networks to computing users. Cloud regions may be part of the offering of multiple cloud service providers, and may exist in multiple geographical areas, for use by the same customer of a cloud desktop service system.

A typical architecture for a Cloud desktop service system 10 is illustrated in FIG. 1. The system 10 has a desktop service control plane 12 that manages virtual desktops supported by two regions 14 (Region A) and 16 (Region B). The desktop service control plane 12 includes a configuration service 20, a monitoring service 22, a desktop management service 24, and a user and group manager 26. Operational data is stored in an event data and telemetry repository 28 and a configuration repository 30. The desktop service plane 12 is managed by an operations center 32. Individual devices each run desktop client applications such as the desktop client applications 34 and 36.

FIG. 1 shows a typical scenario in which the desktop service control plane 12 has the capability of provisioning Cloud desktops, brokering authorized access to the Cloud desktop using the desktop management service 24, monitoring the health of desktops by collecting event and telemetry data, which is stored in the event data and telemetry repository 28 for analysis, and other functions, including storing configuration data related to the desktops and their users in the configuration repository 30. Administrative and troubleshooting facilities are also supported by the monitoring service 22 and the configuration service 20.

The desktop service control plane 12 interacts with desktop clients (such as the desktop clients 34 and 36) and services on the regions 14 and 16. The regions such as the region 14, include groups of region resources 40 and managed Cloud desktops typically running agent software such as the managed Cloud desktop 42. The managed Cloud desktop 42 communicates via the Remote Desktop Protocol (RDP) with the region resources 40. The region resources 40 include a protocol gateway host 44, a virtual network 46, a virtual machine template 48, and a support access device 50. Alternatively, the virtual machine template 48 may be stored in a different Cloud region. Data for the Cloud region is stored in a storage account 52. The desktop service control plane 12 interacts with the protocol gateway services typically running agent software on the protocol gateway host 44, and managed Cloud desktops typically running agent software on the managed Cloud desktop 42.

In order to provide these functions with a particular Cloud region such as the Cloud region 14, certain resources must be consumed, such as the virtual machine used to provide the Protocol Gateway Host 44, the Support Access Device (SAD-A) 50, the virtual network 46 (VN-A), at least one virtual machine template such as the virtual machine template 48 (VMT-A) (depending on the Cloud Provider support for templates), and at least one storage account such as the storage account 52 (SA-A). The resources are shared by all users of managed cloud desktops hosted within the region 14. However, these resources not only incur additional direct Cloud provider utilization costs, such as compute, storage, and licensing costs, but typically also incur additional setup time, administration, and other overhead costs.

FIG. 1 shows that in a multi-cloud, multi-region capable scenario, where there is another desktop client such as the client 38 (DC-B1) desiring to connect to another region such as the region 16, each Cloud region must have its own set of per-region resources allocated. For example, the Cloud region 16 includes groups of region resources 60 and managed Cloud desktops typically running agent software on the managed Cloud desktop 62. The managed Cloud desktop 62 communicates via RDP protocol with the region resources 60. The region resources 60 include a protocol gateway host 64, a virtual network 66, a virtual machine template 68, and a support access device 70. Data for the region is stored in a storage account 72.

Because multiple cloud regions may be equivalently operable to host a particular cloud desktop for a particular user, a decision needs to be made in each case about which Cloud region should be used to provision that Cloud desktop for the particular user. These decisions can be made by cloud desktop service system administrators, or by an automated system such as that described in U.S. application Ser. No. 17/935,395 titled METHOD AND SYSTEM FOR PROVISIONING AND MANAGEMENT OF DYNAMIC DESKTOPS and filed on Sep. 26, 2022, and U.S. application Ser. No. 18/068,986 titled SYSTEM AND METHOD FOR DYNAMIC PROVISIONING OF CLOUD DESKTOP POOLS FROM MULTIPLE PUBLIC CLOUD PROVIDERS and filed Dec. 20, 2022. These patent applications are hereby incorporated by reference in their entirety.

These known methods require that even before pools of desktops may be provisioned within some Cloud region, a set of Cloud regions are “provisioned” with supporting infrastructure, represented in FIG. 1 as resources in each of the example Cloud regions 12 and 14. This infrastructure provisioning includes identifying, enabling, and configuring infrastructure components, such as those illustrated in FIG. 1, in advance so that provisioning of Cloud desktops can occur dynamically (that is, without undue delay) when the Cloud desktops are actually needed.

At a high level, the relationship between provisioning a set of Cloud regions and individual Cloud desktop provisioning is shown in FIG. 2. In this known process, an analysis occurs regarding which Cloud regions should be provisioned (80). For example, if users are located in both California in the US and Delhi in India, it may be a reasonably good choice to provision at least one Cloud region that offers low latency at reasonable cost to each of these locations. Selecting Cloud regions manually involves a high degree of guesswork and is often not directly based on relevant data. Manual selection is especially challenging when there are multiple Cloud service providers involved in a cloud desktop fabric. However, it is not typically feasible to automate this process.

Each Cloud region in the selected region set (defined below) that is not currently provisioned is then provisioned (82), thereby making the provisioned Cloud region ready to support provisioning of Cloud desktops. This may be a manual or automated process, as described in U.S. Pat. Nos. 11,669,349 and 11,550,603. It is also possible that Cloud regions that are no longer considered optimal for the population of users may be de-allocated in some manner that does not impact existing users.

Optimizing the set of Cloud regions in this way is needed because provisioning a Cloud region carries its own costs, independent of the costs of the individual cloud desktops. The costs of provisioning a Cloud region includes both one-time and on-going costs. Such costs include but are not limited to: licensing costs; virtual resource costs (such as costs for virtual networks, data storage, gateway virtual machines, other virtual machines); and time and effort spent to configure and maintain these infrastructures.

For some period of time, the set of Cloud regions is maintained and may be used to support Cloud desktop users (84). A high-level outline of some key steps for maintaining the set of Cloud regions include determining a region associated with a user (86), receiving a desktop request (88), provisioning and using a desktop (90), and deallocating the desktop (92).

Typically one or more of these Cloud regions are associated with a given user in step 86. This may be a manual or automated process, such as those described in U.S. application Ser. No. 17/935,395-METHOD AND SYSTEM FOR PROVISIONING AND MANAGEMENT OF DYNAMIC DESKTOPS and U.S. application Ser. No. 18/068,986-SYSTEM AND METHOD FOR DYNAMIC PROVISIONING OF CLOUD DESKTOP POOLS FROM MULTIPLE PUBLIC CLOUD PROVIDERS. In the step 88, a virtual desktop is requested for use on behalf of a particular user or group of users based on the user profile. In step 90, the desktop is provisioned and used by the user. At some point, the desktop is no longer required and the resources associated with it are de-allocated or re-purposed for another user in the step 92.

At some time, there is a desire to re-evaluate the region set (94), either as part of routine optimization of resource usage, or triggered by changes to the user population or to the services offered by cloud providers. This causes a return to step 80. As explained above, this process is inefficient as it requires unnecessary costs to provisional Cloud regions that may not be used. Alternatively, incorrect selection may result in lack of availability of a virtual desktop to a requesting client device.

There is a need for a Cloud based system that automatically provides the optimal choice of cloud and region for providing a desktop to avoid unnecessary costs or lack of availability of virtual resources. There is also a need for a system that provides the capability to efficiently provision and use desktops from multiple Cloud providers and Cloud regions requiring minimal to no interaction from human operators. There is also a need for a system and method to manage the working set of provisioned Cloud regions, based on utilizing the large amount of data collected about usage, and data collected about Cloud infrastructure, that is available to a Cloud desktop service system.

### SUMMARY

One disclosed example is a virtual desktop system including plurality of available Cloud regions that each include resources for providing a virtual desktop to a client device of a user via a network. A monitoring service is coupled to the available cloud regions. The monitoring service is operable to collect use data from the plurality of available cloud regions in relation to providing virtual desktops to other client devices. A resource management engine is coupled to the available cloud regions. The resource management engine is operable to determine a score for each of a plurality of sets of the plurality of Cloud regions in relation to the client device. A control plane selects a set of the plurality of Cloud regions from the plurality of sets according to the determined scores of each of the plurality of sets to provide the virtual desktop to the client device.

In another implementation of the disclosed example system, the scores are determined on at least one of provider, location, carbon rating, predicted status, predicted capacity, predicted initial latency, subsequent latency, and cost. In another implementation, the control plane provisions all the Cloud regions of the selected set of Cloud regions to provide the virtual desktop. In another implementation, the control plane deactivates Cloud regions that do not belong to the selected set of Cloud regions. In another implementation, the control plane reevaluates scores of each of the Cloud regions of the plurality of the Cloud regions on determining a changed condition. In another implementation, the changed condition includes one of new Cloud regions are introduced, existing Cloud regions are deprecated, a change in a cost structure of a Cloud region, a significant new population of users, a significant change in user locations, and a change in technical capability of resources of one of the Cloud regions. In another implementation, the control plane reevaluates scores of the Cloud regions of the plurality of the Cloud regions periodically. In another implementation, at least one of the plurality of Cloud regions are inactive. The determination of scores includes running a simulation for the inactive Cloud region. In another implementation, the simulation is run based on data from older connections between the user and the inactive Cloud region. In another implementation, the simulation is run based on other users with a similar profile to the user. In another implementation, the simulation is run based on synthetically generated data by agents over simulated networks using test accounts running benchmark tests against the inactive Cloud region. In another implementation, the scoring is based on values of a set of requirement dimensions. In another implementation, the example method includes weighting the values of the set of requirement dimensions. In another implementation, the weighting is based on predetermined rules. In another implementation, wherein the predetermined rules include geographic diversity or Cloud provider diversity. In another implementation, the control plane determines the plurality of sets by reducing the number of total possible sets of the plurality of Cloud regions by eliminating certain of the total possible sets. In another implementation, the sets are excluded based on at least one of user resource requirements, lack of diversity of service, lack of contractual advantages, or lack of increasing the score of the region set.

Another disclosed example is a method for managing Cloud regions to provide a virtual desktop to a user operating a client device. Available Cloud regions that each include resources for providing a virtual desktop to a client device of a user via a network are identified. Use data from the available cloud regions is collected in relation to providing virtual desktops to other client devices via a monitoring service coupled to the available cloud regions. A score for each of the Cloud regions is determined in relation to the client device. A set of the Cloud regions is selected from the sets according to the determined scores of each of sets to provide the virtual desktop to the client device.

Another disclosed example is a non-transitory computer-readable medium having machine-readable instructions stored thereon. When executed by a processor, the instructions cause the processor to identify a plurality of available Cloud regions that each include resources for providing a virtual desktop to a client device of a user via a network. The instructions cause the processor to collect use data from the plurality of available cloud regions in relation to providing virtual desktops to other client devices via a monitoring service coupled to the available cloud regions. The instructions cause the processor to determine a score for each of a plurality of sets of the plurality of Cloud regions in relation to the client device. The instructions cause the processor to select a set of the plurality of Cloud regions from the plurality of sets according to the determined scores of each of the plurality of sets to provide the virtual desktop to the client device.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a prior art Cloud based system that includes Cloud region resources managed by a desktop control plane;

FIG. 2 is a prior art process to provision resources for the Cloud based system in FIG. 1;

FIG. 3 is a high-level block diagram illustrating an example Cloud based system allowing access to virtual desktops from different cloud providers;

FIG. 4 is a block diagram of the resources of a Cloud region and desktop service control plane of the example Cloud desktop fabric in FIG. 3;

FIG. 5 is a table of Cloud regions with corresponding Cloud providers;

FIG. 6 is a map showing the geographical location of the Cloud regions in FIG. 5 and different users;

FIG. 7A is a table of possible sets of Cloud regions based on the Cloud regions in FIGS. 5-6;

FIG. 7B is a table showing a set of users and corresponding ordered lists of preferred Cloud regions in FIG. 7A;

FIG. 8 is a map of Cloud regions and users showing the priority of different Cloud regions for each user;

FIG. 9 is a table showing the weighted scoring for each of the possible sets of Cloud regions for different users;

FIG. 10A is a table of an example additional rules for diversity of regions and providers for evaluating potential sets of Cloud regions;

FIG. 10B is a table of the application of the rules in FIG. 10A to example region sets;

FIG. 11 is a flow diagram of a process to automatically migrate a region set;

FIG. 12 is a flow diagram of a process that allows the example system to collect data to reevaluate the desirability of a region set;

FIG. 13 is a flow diagram of a process that allows the example system to collect data to reevaluate the desirability of a region set; and

FIGS. 14 and 15 illustrate exemplary systems in accordance with various examples of the present disclosure.

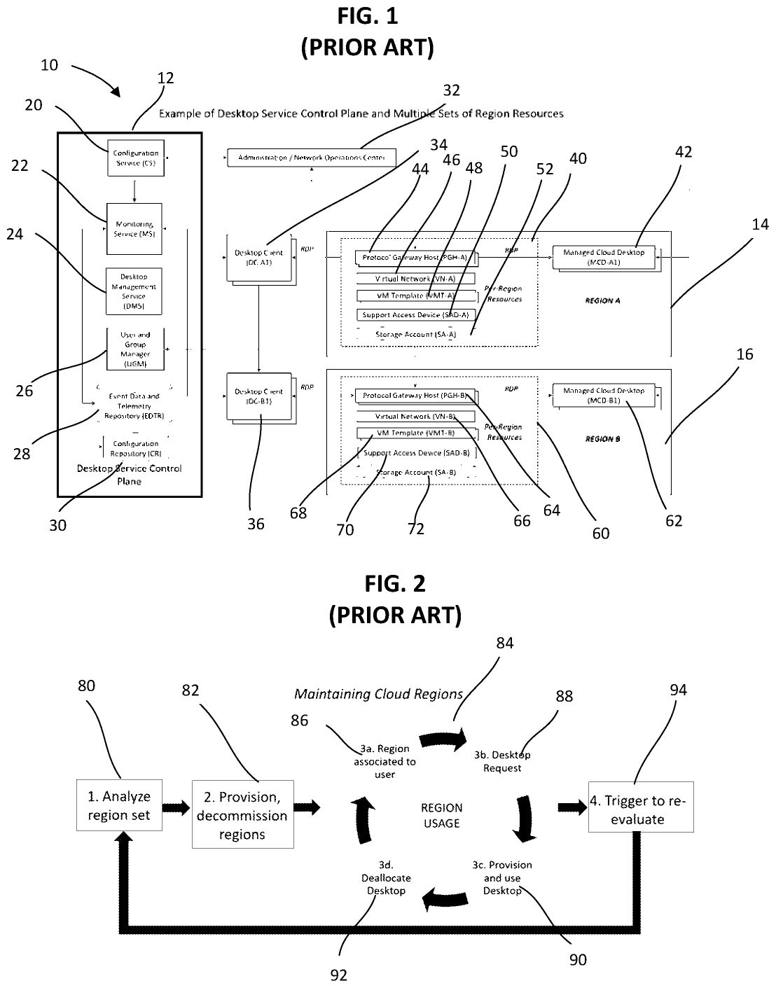

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to efficient identification of a working set of Cloud regions to be provisioned and maintained by the Cloud desktop service system for providing Cloud desktops to different endpoint client devices. The working set of Cloud regions for providing desktops to endpoint client devices may be adjusted based on changing conditions. The example method and system thus are specifically related to the analyzing, provisioning/decommissioning of Cloud Regions and re-evaluation steps in FIG. 2. Adjustments are automatically made based on scoring of Cloud regions. The example system identifies the candidate set of Cloud Regions that should be provisioned to reach the most users at the most optimal cost. This allows for cost efficient utilization of resources for Cloud regions to support users operating client endpoint devices.

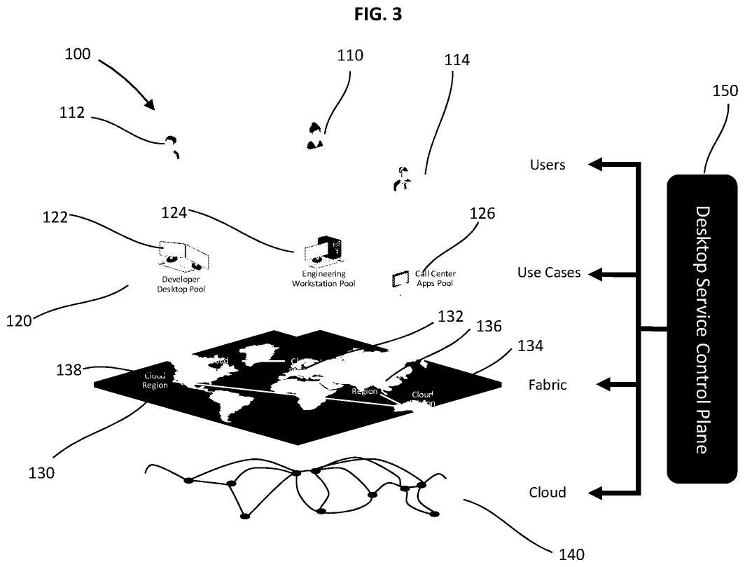

FIG. 3 shows a high level block diagram of a Cloud desktop service system 100. The Cloud desktop service system 100 may also be referenced as a global desktop system because it provides virtual desktops for users globally. The Cloud desktop service system 100 includes four layers, a users layer 110, a use cases layer 120, a fabric layer 130, and a Cloud layer 140.

The users layer 110 represents desktop users having the same computing needs, that may be located anywhere in the world. In this example, the users layer 110 includes users 112 and 114, who are in geographically remote locations and access desktops via computing devices.

The use cases layer 120 represents common global pools of desktops available to serve the users, whereby each global pool is based on a common desktop template. There can be multiple global pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop. The use cases layer 120 represents common logical pools of desktops available to serve the users, whereby each logical pool may be based on common desktop requirements. There can be multiple logical pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop. The desktops in a particular pool may each be supported by different cloud regions based on the requirement of the desktop pool.

For example, pools such as the developer desktop pool 122 or the engineering workstation pool 124 allow users in the pool a desktop that allows access to graphic processing unit (GPU) based applications. Other example applications may include those applications used for the business of the enterprise, for example, ERP (enterprise resource planning) applications or CRM (customer relationship management) applications. These applications allow users to control the inventory of the business, sales, workflow, shipping, payment, product planning, cost analysis, interactions with customers, and so on. Applications associated with an enterprise may include productivity applications, for example, word processing applications, search applications, document viewers, and collaboration applications. Applications associated with an enterprise may also include applications that allow communication between people, for example, email, messaging, web meetings, and so on.

The fabric layer 130 includes definitions and configurations for infrastructure and desktop service resources, including gateways, desktop templates, and others that are applied to Cloud regions. The resources are maintained as Cloud regions such as Cloud regions 132, 134, 136, and 138. Cloud regions can be added or removed as needed. As will be explained, sets of Cloud regions may be automatically provisioned to support different users while minimizing resource costs.

The Cloud layer 140 implements the resources defined by the use case layer 120 and fabric layer 130, including virtual desktops, infrastructure, and other virtual resources, all of which are virtual machines or other virtual resources hosted in a public cloud.

The layers 110, 120, 130, and 140 are created and orchestrated by a desktop service control plane 150 that can touch all the layers. The desktop service control plane 150 is a key component to orchestrate a cloud desktop service system such as the cloud desktop service system 100 in FIG. 3. The desktop service control plane 150 can manage the entire lifecycle of a desktop service implementation, from creating and managing the required desktops, to monitoring and analyzing the stream of operational data collected, enforcing security policies, and optimizing the experience for IT administrators and desktop users. For example, the desktop service control plane 150 may register a set of a virtual networks, virtual storage resources, and more. Within a virtual network, the control plane 150 may further register and coordinate the use of gateways, enterprise connectors, desktop templates, connection brokers, and more.

The two desktop users 112 and 114 in different parts of the world who are each able to access an example high-performance desktop service from the Cloud desktop service system 100. Users, such as users 112 and 114, each may use a client device to access the desktop service. Client devices may be any device having computing and network functionality, such as a laptop computer, desktop computer, smartphone, or tablet. Client devices execute a desktop client to access remote applications such as the desktop. The client application authenticates user access to the applications. A client device can be a conventional computer system executing, for example, a Microsoft™ Windows™ compatible operating system (OS), Apple™ OS X, and/or a Linux distribution. A client device can also be a client device having computer functionality, such as a personal digital assistant (PDA), mobile telephone, tablet, video game system, etc. In this example, the client application displays an icon of the desktop or desktops available to the user. As will be explained, the desktop is made available to the user through the client application on the user device.

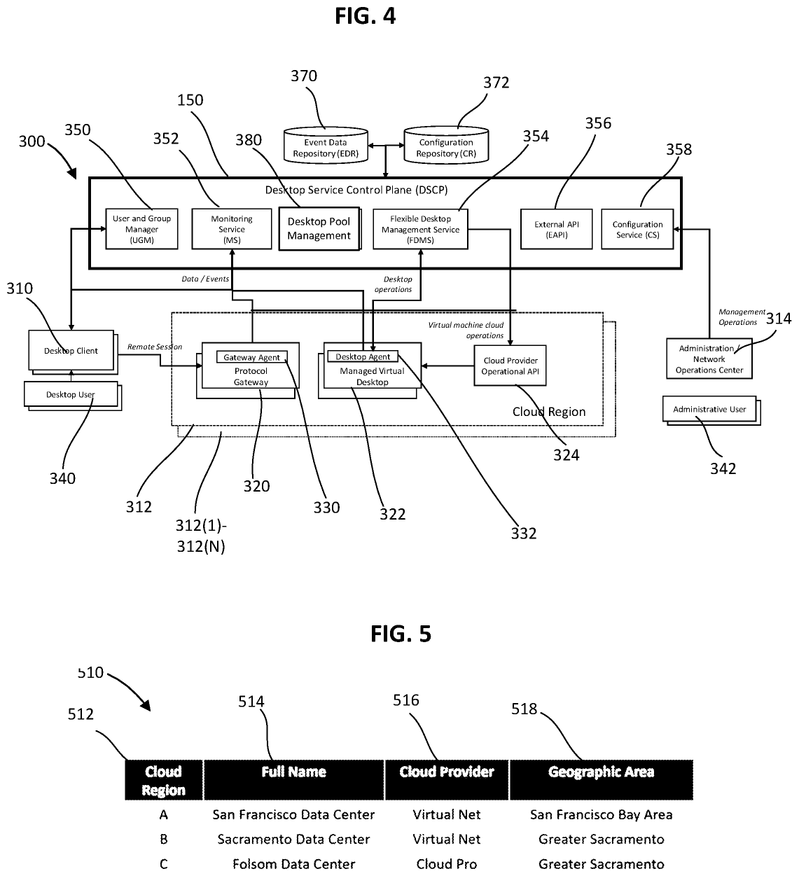

FIG. 4 is a block diagram of some examples of components of the Cloud desktop service system 100, including an example set of desktop clients 310, a Cloud region 312, and an administration center 314, that interact with and can be orchestrated by the desktop service control plane 150. The desktop client 310 communicates with the desktop service control plane 150 in order to be registered with the fabric, assigned a desktop, remotely configured, and for other purposes. One other purpose is to monitor latency, response-time, and possibly other data and events that measure quality of user experience. Another purpose is to report user interaction events. There may be multiple Cloud regions (e.g., cloud regions 312(1) to 312(N)) similar to the Cloud region 312, but only one Cloud region 312 is shown in detail for simplicity of explanation. The Cloud region 312 may include a set of protocol gateways 320, a set of managed virtual desktops 322, and a cloud service provider operational API 324. These components all communicate with the desktop service control plane 150. The Cloud region 312 may be one of the Cloud regions 132, 134, 136, and 138 in FIG. 3.

Such Cloud regions include servers that host the various applications as well as appropriate storage capabilities, such as virtual disks, memory, and network devices. Thus, the Cloud region 312 typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. A Cloud region may include a firewall to control access to the applications hosted by the Cloud region. The firewall enables computing devices behind the firewall to access the applications hosted by the cloud region, but prevents computing devices outside the firewall from directly accessing the applications. The firewall may allow devices outside the firewall to access the applications within the firewall using a virtual private network (VPN).

The protocol gateway 320 may be present to provide secure public or internal limited access to the managed virtual desktops, that may be deployed on a virtual machine of its own. A gateway agent 330 is software that is deployed on that gateway virtual machine by the desktop service control plane 150, and serves to monitor the activity on the gateway 320, and enable the desktop service control plane 150 to assist in configuration and operations management of the gateway 320.

The example desktop client 310 is software and device hardware available in the local environment of a desktop user 340 to remotely access a managed virtual desktop using a remote desktop protocol. The desktop client 310 communicates with the desktop service control plane 150 to monitor latency, response-time, and other metrics to measure quality of user experience and also supports a remote display protocol in order for users to connect to a desktop application run by the cloud region 312.

The managed virtual desktop 322 is itself provisioned and maintained by the desktop service control plane 150. A desktop template may be used to manage pools of such managed virtual desktops. The desktop template is used to instantiate virtual desktops with the correct virtual machine image and a standard set of applications for a particular use case. A desktop agent such as desktop agent 332 is software that is deployed on that managed virtual desktop by the desktop service control plane 150, and serves to monitor the activity on the managed virtual desktop, and enable the desktop service control plane 150 to assist in configuration and operations management of the managed virtual desktop.

The Cloud service provider operational application programming interface (API) 324 presents services provided by the Cloud service provider that also participate in the management of the virtual machine. This can be utilized by a desktop service control plane 150 to perform operations like provisioning or de-provisioning the virtual machine.

Administrative users 342 can interact with operations reporting interface software at the administration center 314 that allows management and administration of the desktop service control plane 150.

Other components and services may interact with the desktop service control plane but are omitted from FIG. 4 for simplicity, such as enterprise connectors, network monitoring services, customer relationship management (CRM) systems, and many others.

The desktop service control plane 150 itself can perform many internal centralized functions also not depicted in in FIG. 4, including pool management, user and group management, cloud service adapters, virtual desktop templates, data analysis, high-availability management, mapping users to the optimal Cloud region, security policy management, monitoring, compliance, reporting, and others.

The control plane 150 includes a user and group manager 350, a monitoring service 352, a desktop management service (DMS) 354, an external API (EAPI) 356, and a configuration service (CS) 358. The control plane 150 may access an event data repository 370 and a configuration repository 372. Although only one Cloud region 312 is shown in detail, it is to be understood that the control plane 150 may facilitate numerous Cloud regions.

The monitoring service 352 makes both routine and error events available to administrators and can analyze operational performance and reliability. The monitoring service 352 interacts with components including the desktop client 310, desktop agent 330, gateway agent 332 to obtain operational data relating to the desktop, and operational data generated by the control plane 150 itself. The monitoring service 352 stores all such operational data for later analysis. As will be explained desktop clients may report information about the location of the user. Desktop agents can report information about the duration of each connection, and other performance information, including the applications used by the desktop. Gateway agents can also report performance information because the gateway agent sits between the desktop client and the desktop on the network.

The desktop management service 354 interacts with the one or more managed virtual machines (MVMs) 322 in the cloud region 312 and other cloud regions 312(1) to 312(N). In this example, the desktop management service 354 manages resources for providing instantiated desktops to the users in the logical pools, orchestrating the lifecycle of a logical desktop. As will be explained, the management service 354 includes a desktop pool resource management engine 380. The desktop pool resource management engine 380 determines the requirements for desktop pools and the constraints of the regional cloud regions for optimal allocation of desktops in the desktop pool, and may use the data collected by the monitoring service to determine optimal allocation of virtual desktops.

The administration center 314 works directly with the data control plane 150 as its primary human interface. The administration center 314 allows the administrative user 342 to configure the functions of the control plane 150 through the configuration service 358. The configuration service 358 supports editing and persistence of definitions about the desktop service, including subscription information and policies. The administration center 314 may be where the desktop requirement dimensions are configured by the administrative user 342. The system 300 in FIG. 3 allows the creation and management of desktop pools in accordance with the process described herein.

The example method considers any specific enumeration of Cloud regions that could possibly be made available to provide Cloud desktops to users as a region set. A particular region set is considered as a provisioned region set if all of its enumerated Cloud regions have, in fact, been provisioned and are available to users of a specific customer as described in the provisioning step 82 of FIG. 2 above.

FIG. 5 shows a table 510 of three example Cloud regions. In the simplified illustration in the table 510, there are three Cloud regions uniquely identified as regions A, B, and C in a first column 512. A second column 514 lists the name of the Cloud region. A third column 516 lists the name of the Cloud provider that supports the Cloud region. A final column 518 lists the geographical area of the Cloud regions. As shown in the table 510 in FIG. 5, each Cloud region is associated with a physical data center maintained by some Cloud provider or private entity (fictional names for the Cloud regions are used in table 510). Each Cloud region is located in some geographic area as listed in the column 518.

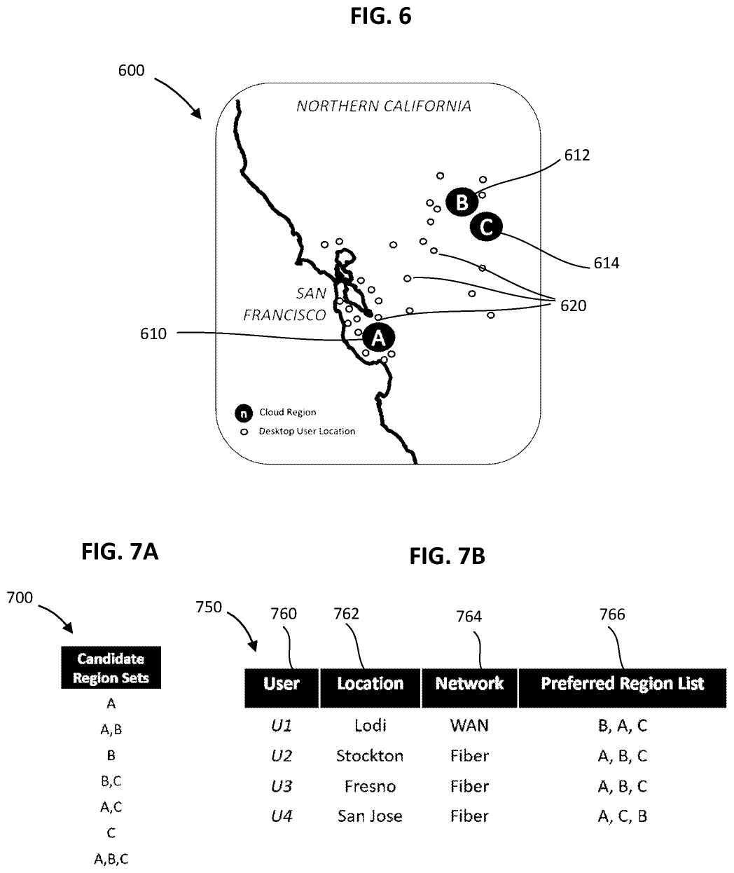

Each of these Cloud regions is available over some kind of network to users in various locations. FIG. 6 shows a map 600 of a geographic area that includes the three Cloud regions, or data centers in the table 510 in FIG. 5. Thus, the map 600 includes a Cloud region 610 that corresponds to Cloud region A listed in table 510, a Cloud region 612 that corresponds to Cloud region B listed in table 510, and a Cloud region 614 that corresponds to Cloud region C listed in table 510. The location of multiple possible users of client devices that may be supported by the Cloud regions 610, 612, and 614 are all illustrated as dots 620 in specific geographical locations. In this scenario, any of the users could access a Cloud desktop that is provisioned for them in any of the three data centers of the Cloud regions 610, 612, and 614 using a network connected to a client device.

FIG. 7A shows a table 700 that shows the possible combinations or single sets of the three Cloud regions A, B, and C in the table 510 in FIG. 5. As shown in the table 700, when there are n members of a set there are 2n−1 (2 to the power of n, minus 1) non-empty subsets, or in this example, 7 possible combinations of the 3 members of the set of Cloud regions as shown in the table 700.

Intuitively, the lowest cost region set would consist of the single lowest-cost Cloud region. Thus the “region set” with the lowest cost is a single Cloud region. The best performing region set would consist of all three Cloud regions, as the combination of these regions offer the lowest latency connections to users whose locations span the entire area. From the perspective of a Cloud desktop service system, the optimal provisioned region set is likely to be neither of these options but instead one of the other region sets in table 700. The example system identifies the candidate region set that should be provisioned to reach the most users at the most optimal cost.

In order to identify the optimal regional set, a region set score is determined for each of the possible region sets. The region set score is a metric that allows comparison of candidate region sets (whether provisioned or not) to allow them to be compared in desirability. The capability to update region set scores frequently requires a large amount of analysis of dynamically generated user and infrastructure data and is not feasible to be done manually.

It should be understood that the example given in FIG. 7A and FIG. 7B deliberately uses an artificially low number of example regions for clarity. However, as the number of regions is increased, the number of candidate region sets grows quickly, requiring automated calculation to perform the analysis in real-time. One reason is that the result of the formula 2ⁿ−1 grows exponentially with the size of the Cloud Regions, n. For example, even while increasing the number of regions to 10 results in 2¹⁰−1 or 1,023 candidate region sets, increasing that to 30 Cloud regions, which may be a realistic number, results in 2³⁰−1 or 1,073,741,823 candidate region sets, and the results explode rapidly with any further increases in the number of regions. Furthermore, the data used for the analysis may change frequently and analysis performed by an information technology professional will not be able to keep up with the stream of new data available.

The scores for a Cloud region such as the Cloud region 610 in FIG. 6 may be determined through requirement dimensions and a score or scores based on meeting requirements of resources of a Cloud region for a particular user. In this example, the flexible desktop management service 354 in FIG. 4 determines the requirement dimensions and scores based on the collected data. Other separate modules or routines may perform the score determination for the Cloud regions.

For example, a typical set of requirement dimensions may include an anticipated demand schedule, a user location requirement, a set of desktop capability requirements, a cost constraint requirement, a response time requirement, and a carbon footprint requirement. The anticipated demand schedule is the number of anticipated Cloud desktops used during certain times and days. The user location requirement is the physical location of the Cloud desktop user or a concentration of Cloud desktop users. The desktop capabilities requirement may include processing capabilities (e.g., CPU type), storage capabilities (e.g., memory size, disk class, disk size), and operating system requirements. The desktop capabilities are thus those that are defined by the requirements of the users in the particular logical pool such as those who need access to a sales desktop. Such requirements for a sales desktop may differ from other types of desktops such as an engineering desktop. The cost constraint requirement can be used by the system to differentiate between similar services that vary in underlying cost. For example, some Cloud regions charge a higher price than others for the same resource and the cost constraint can be used as input in planning the prioritized order of Cloud region selection. The response time requirement includes the initial response time (affecting the experience of waiting to connect to a new session) and the subsequent response time (affecting the perception of user interaction lag) of the desktop system. The carbon rating is a desired score in some rating systems (such as estimated tons of CO2 emitted per year, described as a percentage of some target) that may be used to compare the relative environmental impact of virtual desktops hosted by different Cloud regions.

In the referenced U.S. application Ser. No. 17/935,395 and U.S. application Ser. No. 18/068,986 for implementing dynamic pools of cloud desktops, there are further disclosures of how usage data, configuration data, and weighted cloud region criteria scores may be used to create scores for a prioritized list of provisioned Cloud regions for a single user or a group of users according to known user profiles.

The examples disclosed herein builds on the systems that create a prioritized list of provisioned Cloud regions for users. The example system does not require that a Cloud region be provisioned for a particular customer or set of users in order to be evaluated. This enables the system to determine a region set score for candidate Cloud regions that have not yet been provisioned or were provisioned but now are inactive.

The evaluation of each of the possible region sets may be considered as a combination of simulated usage information with any available actual usage information pertinent to every candidate cloud region, for scoring purposes. The simulation applies various heuristics to known facts about a user profile, and a candidate Cloud region, in order to predict what actual results might exist for an actual user in that candidate Cloud region. For example, if a user with a certain profile were to connect to the candidate region from a known location, over known networks, using known protocols, and running known applications, using known usage patterns, the system can apply heuristic rules to make a prediction of factors such as network bandwidth, network latency, connection stability, with some degree of possible error. The combination of actual and simulated usage information uses some statistical rules that may be configurable. For example, actual usage data will typically be greatly weighted for consideration in contrast to simulated usage data. Furthermore, actual usage data can be used to provide feedback to automatically refine the heuristic rules or other configurations in order to make usage simulation more accurate over time and with greater actual usage.

A full evaluation freshly evaluates the prioritized region list for every user (or possibly clusters of users in similar locations with similar network connections). For example, if a new user U5 is added but the system has no actual usage data for the new user, the system instead identifies existing users such as user U4 that are in the same location and have the same quality of network connection as the new user U5. The system may choose to use actual data from a group of users similar to U4 in order to predict results for user U5. In this case, the actual usage data from users such as U4 provides simulated usage data for user U5.

FIG. 7B shows a table 750 that lists users and a list of preferred regions for each user. The table 750 has a first column 760 listing the users, a second column 762 listing the location of the user, a third column 764 listing the network type, and a fourth column 766 with a list of the example Cloud region sets in FIG. 7. The table 750 shows the result of users with various connection capabilities in various locations evaluated against all the Cloud regions using the methods in the referenced disclosures. The resulting order of preferred Cloud regions listed in the column 766 are based on automated analysis and weighted scoring of each possible Cloud region that may support the user as described herein.

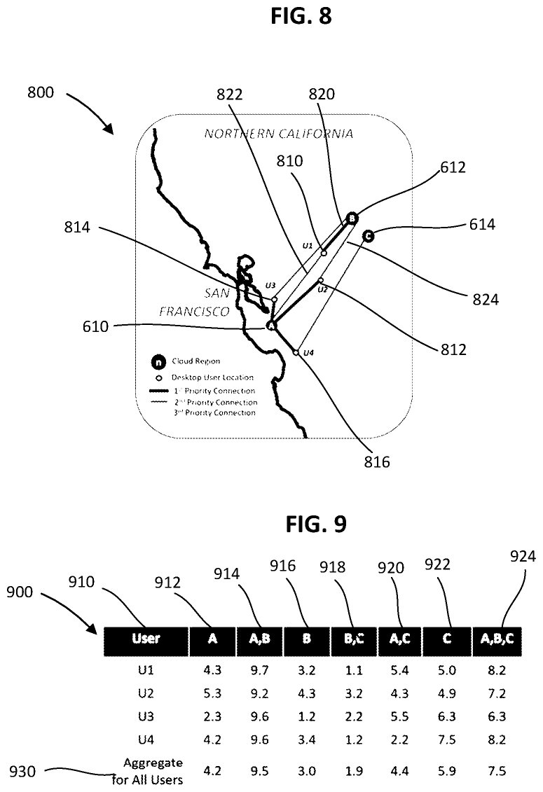

FIG. 8 shows a map 800 that shows the priorities of connections in the table 750 in FIG. 7B. The map 800 includes the Cloud region locations 610, 612, and 614 previously shown in FIG. 6. Each of the users in the table 750 are represented by points 810, 812, 814, and 816 that represent the physical location of the users. A set of lines from the users 810, 812, 814, and 816 to each of the Cloud region locations 610, 612, and 614 shows the relatively priority of each connection depending on the thickness of the lines. The priority is determined by the scores calculated for each potential Cloud region as explained above. In this example, the highest priority Cloud region has the highest score and other lower scored Cloud regions have corresponding lower priorities. For example, a line 820 shows a first priority Cloud region such as Cloud region B for the user 810. A line 822 that is less thick than the line 820 shows a second priority Cloud region such as Cloud region A for the user 810. A thinner line 824 shows the third priority Cloud region such as Cloud region C for the user 810.

The same referenced methods that compute the prioritized region list for each user can also be used to generate a weighted score for each user for each Cloud region. Furthermore, scoring can take place for a simulation of a Cloud desktop being provided for a user by a Cloud region even if that Cloud region has not yet been provisioned for use by that customer, or even if there is no existing data about the specific user. This simulation may be run because there may be existing data from older connections between the user and the Cloud region. The simulation may also be run because data may exist for users with a similar profile, such as location, predicted latency, or application type. In the example shown in FIG. 8, if users U1 and U2 have the same usage profile, and have similar virtual machine requirements, their data may be interchangeable for the purposes of this analysis. This is true for users that may belong to multiple customers, even though the resulting region set scores and actual region set is specific to a single customer.

Sample data may be synthetically generated by agents over simulated networks using test accounts running benchmark tests against the Cloud region. This allows Cloud regions to be included in the analysis even if they are brand-new or have had little recent actual usage.

When considering the additional costs of provisioning Cloud regions and using standard analytical techniques, a weighted score for each user for each candidate region set may be determined. This can in turn be aggregated to result in a weighted score for each candidate region set for the entire population of users. FIG. 9 shows a table 900 of example weighted scores for different region sets. The table 900 represents a simplified example for purposes of clarity. The table 900 includes a first column 910 that lists the four example users in FIG. 8. A series of columns 912, 914, 916, 918, 920, 922, and 924 show different sets of Cloud regions and corresponding weighted scores for each of the users relative to those sets of Cloud regions. A row 930 shows an aggregate score for each of sets of Cloud regions.

The aggregation function depicted in this example is a simple average but could be replaced by any number of more sophisticated data science techniques for normalizing, aggregating, and generalizing insights out of large amounts of data. In this example, the candidate region set consisting of Cloud regions A and B has the highest aggregate score of 9.5, as illustrated in the column 914. In this example, the candidate region set (A, B) in column 914 even outperforms the candidate region set of Cloud regions A, B, C (all cloud regions provisioned) in column 924, presumably because the set with all available Cloud regions is the costliest solution.

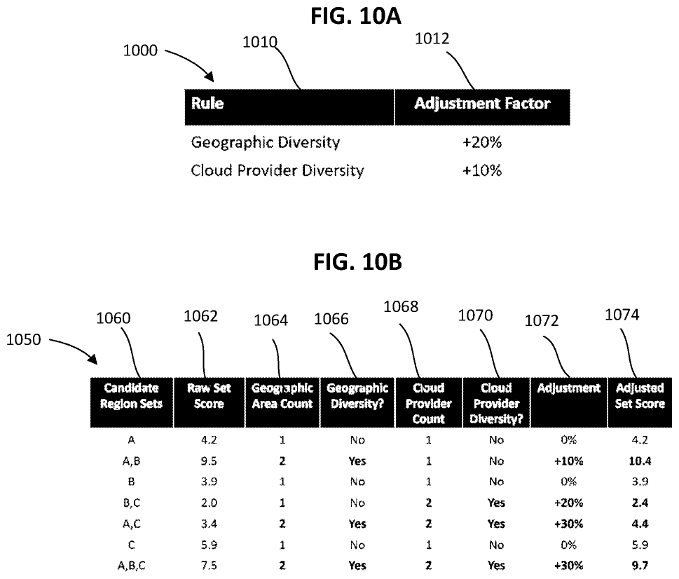

Additional rules for evaluating candidate region sets may be applied as shown in the tables 1000 and 1050 in FIG. 10A and FIG. 10B. Additional enhancements of the evaluation of region set scores are possible by applying other weighted adjustments to raw scores based on heuristic rules or other techniques. These have the advantage of applying criteria about the region set as a whole, not merely aggregating data derived from scores of individual regions.

Two examples of such heuristics, geographic diversity and Cloud provider diversity, could be used to reflect goals of diversity of the Cloud regions in the set to create a higher availability of Cloud regions to minimize risk of service disruption as shown in the example table 1000 in FIG. 10A. The table 1000 includes a list of rules 1010 and a corresponding column of adjustment factors 1012 for geographic diversity of the Cloud regions and Cloud provider diversity. The example geographic diversity factor is based on the observation that a region set with all cloud regions in the same greater geographical area is more likely to be impacted by localized disasters, such as earthquake, flood, and so on. The example Cloud provider diversity factor is based on the observation that a region set with all Cloud regions maintained by the same Cloud provider and/or private datacenter is more likely to be impacted by provider-wide outages or other risks associated with the cloud provider.

One technique for implementing these heuristics is to maintain a table of adjustment factors for each rule, as exemplified by the table 1000. In this example the two example diversity rules (geographic diversity and Cloud provider diversity) that are configured to add a bonus value to a raw region set score if the region set triggers the rule. While there are only two rules and corresponding bonus values, it is to be understood that there may be any number of adjustment factors and corresponding bonus values.

Each region set may be further evaluated with regard to the rules, either using specifically coded logic or possibly some other logical system. The table 1050 in FIG. 10B illustrates an evaluation result for each of the example region sets in FIG. 7A. The table 1050 includes a column of region sets 1060, a raw score column 1062, a geographic area count column 1064, a geographic diversity column 1066, a Cloud provider count column 1068, a Cloud provider diversity column 1070, an adjustment factor column 1072, and an adjusted set score column 1074.

For purposes of the geographic diversity rule reflected in the column 1066, a region set must have Cloud regions that encompass at least two geographic areas to qualify for the geographic diversity bonus. For purposes of the Cloud provider diversity rule reflected in the column 1070, a region set must have Cloud regions that encompass at least two Cloud providers to qualify for the Cloud provider diversity bonus. The adjusted set scores in the column 1074 are determined by adding the initial set score in the column 1062 to the adjustment factor in the column 1072 multiplied by the set score. The scores resulting in higher scores in the adjusted region set score column 1074 are shown in bold in the table 1050. For example, the set A and C has both geographic diversity as well as Cloud provider diversity resulting in a +30% adjustment. The set B and C only has Cloud provider diversity resulting in a +20% adjustment. The set A and B only has geographic diversity resulting in a +10% diversity.

The example technique may be generalized to add any additional criteria to region set scoring beyond the attributes of individual Cloud regions. The specific manner of computation of bonuses (or penalties) to adjust region set scores can vary depending on the implementation and is not meant to be constrained by the examples illustrated here.

As noted above, manual analysis techniques are not feasible because the number of candidate cloud regions grows exponentially with the number of Cloud regions. This exponential explosion can create implementation concerns for automated analysis techniques. Therefore, some techniques for filtering down the list of candidate region sets are strongly desirable even given powerful data processing capability. For example, there may be a pre-evaluation of the overall list of Cloud regions based on Cloud infrastructure alone, to pare the list of region sets down in advance. This results in more efficient computation since fewer regions sets must be evaluated.

Heuristic filtering can also be done in many ways, such as rules that may be introduced and maintained by system architects or administrators. Some examples include: 1) All regions in candidate region sets must meet the user requirements, for example, in the virtual machine types (cloud desktop SKU) offered; 2) Exclude cloud regions that do not significantly offer more diversity of service over existing cloud regions; 3) Include only preferred cloud regions as published by cloud providers (sometimes called ‘hero’ regions), or which have contractual advantages; or 4) Only add cloud regions to the list if they are likely to result in significantly higher scores given changing conditions, such as new locations for users or planned service cost changes. For example, if the cost structure of a Cloud region makes that Cloud region less desirable, the example system can be used to find an acceptable replacement.

Just as in the known manual process of allocating Cloud regions, the evaluation and upgrade process may be triggered periodically, or based on external events. Examples of external events include: 1) Cloud regions are introduced or deprecated by cloud providers; 2) Changes in cost structures of cloud service providers; or 3) Preparing for significant new populations of users, user locations, or use cases that may be better served by a different region set for a group of users of the customer.

Advances in technology can be described as an event or set of events that trigger a re-evaluation of each region score. For example, a Cloud provider may invest in updated hardware for a Cloud region, significantly boosting the performance of network controllers and/or host servers on which virtual machines are provisioned. When region scores change, this may trigger the re-evaluation of the region set scores that may be derived from them.

As described above, a provisioned region set that is in use has a region set score that can be based on a combination of actual usage and/or the techniques explained above for simulated usage, and various heuristic factors. In the example in FIG. 10B, the only provisioned Cloud regions are currently in San Francisco and Modesto (Cloud Regions A and C) and the actual region set A and C has an adjusted score of 4.4. In this particular case there is an opportunity to improve results because the analysis indicates that the region set A, B has a significantly higher region set score, for a combination of reasons. This indicates a significant potential improvement in desired outcomes by migrating the actual region set to a candidate region set such as Cloud regions A and B.

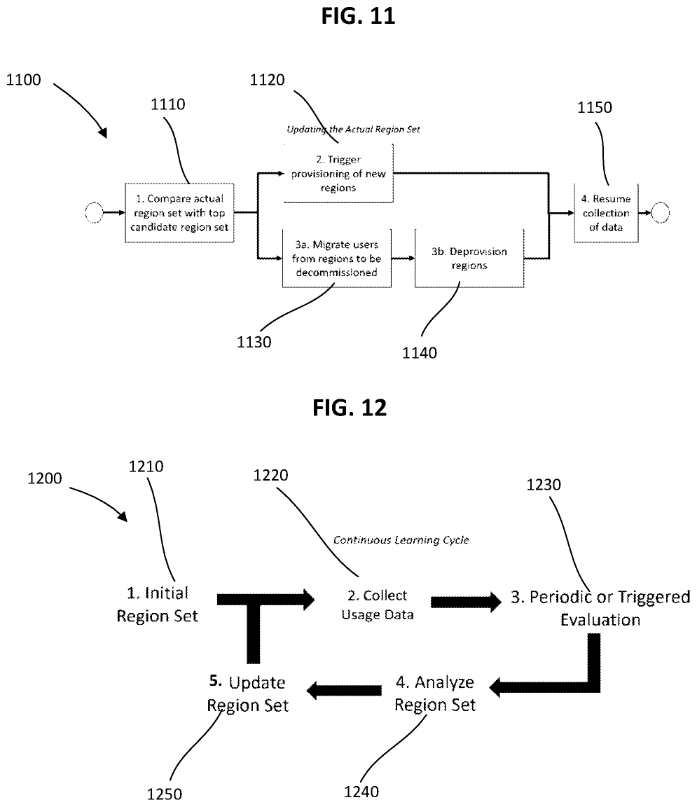

FIG. 11 is a process diagram 1100 showing an example of automatically migrating a current region set to a candidate region set. In one example, the region sets are reevaluated periodically such as once every month. Alternatively, the reevaluation of region set scores could be triggered by actual results that are lower than expected according to some heuristics and/or configurations. Alternatively, the reevaluation could be performed by an administrative command. Once the evaluation is done, the score of the actual region set is compared with the score of the top candidate region set (1110). The score of the top candidate region set is compared to all other candidate region sets.

The comparison of the score of the actual region set with the top candidate region set may find that there may be no changes recommended. For example, there may be a threshold of small differences in scores that will be ignored. In this case, the routine in FIG. 11 is not performed and the current region set is maintained to support users. This logic could be a rule using a configured threshold. For example, a transition of the region set may only be triggered when the predicted performance improvement is greater than 20%.

If the transition is triggered, the system compares the actual region set with the top candidate region set generates a list of regions to be provisioned, and a list of cloud regions to be decommissioned to achieve the candidate region set. Using the example given above, where the current region set is transitioning from A, C to A, B, the list of regions to be provisioned consists of the single region B, and the list of regions to be de-provisioned consists of the single region C. The system then will provision any inactive Cloud regions (in the previous example, region B) to complete the candidate region set (1120). The system will also migrate users from any current Cloud regions that are not in the candidate region set (1130) (in the previous example, region C). The system then deactivates the Cloud regions that are currently not in the candidate region set (1140) (in the previous example, region C). After the system performs necessary provisioning (1120) and deactivation (1140), the system resumes collection of data on the performance of the now current region set (1150). Throughout and after this process usage data continues to be collected to enable future analysis cycles. It is also possible that it will trigger analytical reports and an approval process before automated action is initiated.

Cloud regions to be provisioned may be set up automatically, or manually, as is known in prior art and in the example process described in U.S. Pat. No. 11,550,603 B2—METHOD AND SYSTEM FOR SIZING A CLOUD DESKTOP FABRIC in step 1120. Once a new Cloud region is provisioned, the provisioned Cloud region can start serving users along with other Cloud regions enabled for the Cloud desktop service system.

Cloud regions to be decommissioned have a more elaborate process, to avoid impacting existing users. The cloud desktop service system begins avoiding using such Cloud regions that are to be decommissioned for new users or new desktop requests. This will naturally “drain” the Cloud region of users. If necessary, the Cloud desktop service system can more actively shift users to a new Cloud region once the new Cloud region becomes available, in a manner that minimizes disruption to the user. The capability of dynamically shifting users between cloud regions is described in the above referenced applications. Once the cloud region is free of users, its resources may be deallocated, including local storage accounts, gateways, virtual networks, other virtual machines, or anything else that is consumed as part of maintaining the provisioned Cloud region.

FIG. 12 shows an example process how the example system learns over time to optimize user experience and minimize costs based on different region sets. The system begins by provisioning an initial region set for supporting a user (1210). During operation of the active Cloud regions in the initial region set, the system collects usage data (1220). After a certain period or in response to an event another evaluation is triggered (1230). As explained above, the evaluation may be automatically performed periodically, through administrative action, or automatically because of monitored situations such as a Cloud region become unavailable, detection of poor performance, or other triggers. On triggering a new evaluation, the example system recalculates the scores for the current region set as well as different candidate region sets (1240). Based on the analysis, the system runs the routine in FIG. 11 to provide an updated region set if necessary (1250). The system then cycles back to collecting usage data (1210).

The same techniques can be extended to managing other kinds of Cloud resources related to Cloud desktop service systems. A related concern is the selection of an ISP (Internet Service Provider) for use in providing Cloud desktops to users. One example is when there are multiple paths to connect a user with a Cloud region. For example a user may reach a Cloud region by either: 1) a direct connection to the Cloud region using a public internet connection provided by the ISP; or 2) a connection to a high-speed backbone provided by the Cloud region, typically at higher cost.

Using the techniques described above, the network options for each user could be evaluated, possibly requiring simulation, to develop a network connection profile recommended for the user, and this could be automatically re-evaluated over time.

The system example system allows efficiently reduction of overhead costs of providing Cloud regions, including but not limited to: Virtual networks; Temporary file storage accounts and storage charges; Virtual machines used for gateways, such as remote desktop protocol (RDP) gateways, and their usage; Security services; Costs for support and monitoring of cloud regions through the evaluation of available region sets. The example system allows users in dispersed locations to benefit from having low-latency connections to available multiple Cloud regions by selecting a region set that reduces resource costs.

The example method and system of evaluating region sets, allows eliminating guesswork in determining Cloud regions to support a user. The example method and system allows multiple cloud provider architectures to be used.

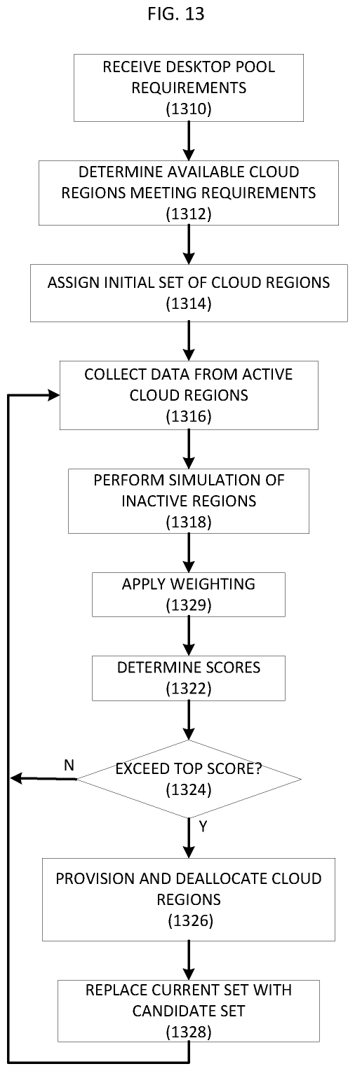

FIG. 13 is a flow diagram of the routine to automatically transition the working region set over time. In this example, the machine readable instructions comprise an algorithm for execution by: (a) a processor, (b) a controller, and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowcharts illustrated in FIG. 13, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The routine first receives a set of requirements for virtual desktops in a desktop pool (1310). The routine then determines the available Cloud regions that meet the requirements for providing the desktops of the desktop pool (1312). The routine then assigns an initial set of Cloud regions to provide desktop services to the user (1314). The routine collects information from the available cloud regions to determine a score (1316). The routine determines a simulation of any non-available cloud regions (1318). The routine determines scores for each potential region set (1320). The routine then applies weighting to the scores for each of the cloud region sets (1322). The routine then compares the top candidate region set with the current set (1324). If the score of the top candidate set does not exceed the score of the current region set, the routine loops back to collecting information (1316).

If the score of the top candidate region set exceeds the score of the current region set, the routine matches the candidate set by provisioning any required Cloud regions and deallocating any unnecessary Cloud regions (1326). The routine then sets the candidate region set as the current set (1328) and loops back to the collection of information (1316).

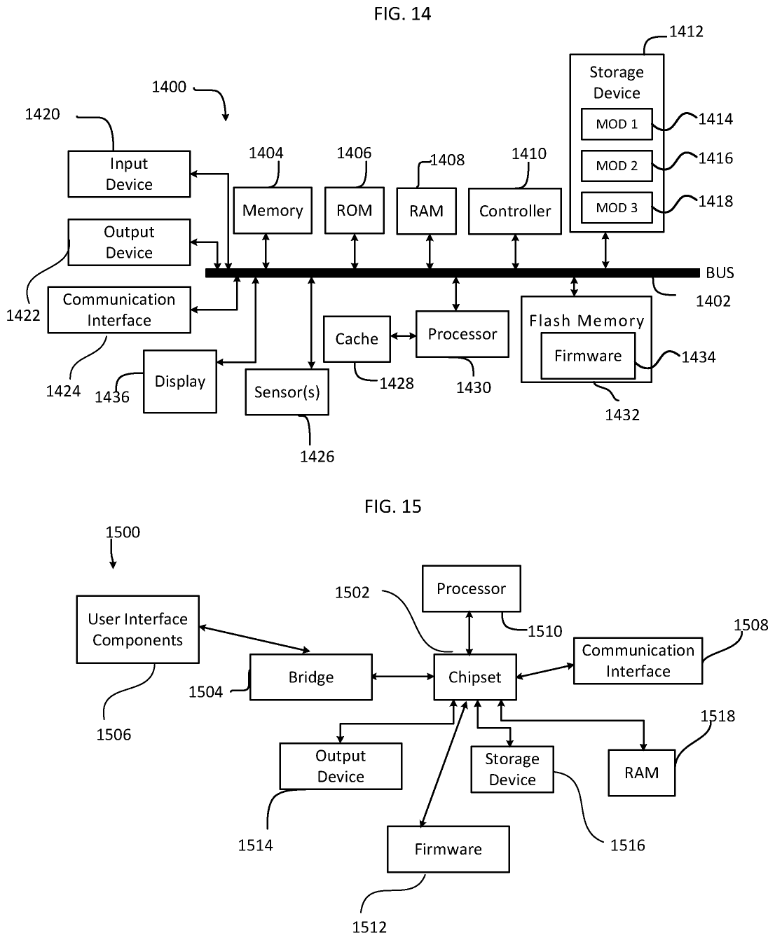

FIGS. 14-15 illustrate an example computing system 1400, in which the components of the computing system are in electrical communication with each other using a bus 1402. The system 1400 includes a processing unit (CPU or processor) 1430 and a system bus 1402 that couple various system components, including the system memory 1404 (e.g., read only memory (ROM) 1406 and random access memory (RAM) 1408), to the processor 1430. The system 1400 can include a cache of high-speed memory connected directly with, in close proximity to, or integrated as part of the processor 1430. The system 1400 can copy data from the memory 1404 and/or the storage device 1412 to the cache 1428 for quick access by the processor 1430. In this way, the cache can provide a performance boost for processor 1430 while waiting for data. These and other modules can control or be configured to control the processor 1430 to perform various actions. Other system memory 1404 may be available for use as well. The memory 1404 can include multiple different types of memory with different performance characteristics. The processor 1430 can include any general purpose processor and a hardware module or software module, such as module 1 1414, module 2 1416, and module 3 1418 embedded in storage device 1412. The hardware module or software module is configured to control the processor 1430, as well as a special-purpose processor where software instructions are incorporated into the actual processor design. The processor 1430 may essentially be a completely self-contained computing system that contains multiple cores or processors, a bus, memory controller, cache, etc. A multi-core processor may be symmetric or asymmetric.

To enable user interaction with the computing device 1400, an input device 1420 is provided as an input mechanism. The input device 1420 can comprise a microphone for speech, a touch-sensitive screen for gesture or graphical input, keyboard, mouse, motion input, and so forth. In some instances, multimodal systems can enable a user to provide multiple types of input to communicate with the system 1400. In this example, an output device 1422 is also provided. The communications interface 1424 can govern and manage the user input and system output.

Storage device 1412 can be a non-volatile memory to store data that is accessible by a computer. The storage device 1412 can be magnetic cassettes, flash memory cards, solid state memory devices, digital versatile disks, cartridges, random access memories (RAMs) 1408, read only memory (ROM) 1406, and hybrids thereof.

The controller 1410 can be a specialized microcontroller or processor on the system 1400, such as a BMC (baseboard management controller). In some cases, the controller 1410 can be part of an Intelligent Platform Management Interface (IPMI). Moreover, in some cases, the controller 1410 can be embedded on a motherboard or main circuit board of the system 1400. The controller 1410 can manage the interface between system management software and platform hardware. The controller 1410 can also communicate with various system devices and components (internal and/or external), such as controllers or peripheral components, as further described below.

The controller 1410 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 1410 to initiate or conduct specific hardware recovery procedures or operations, as further described below.

The controller 1410 can also include a system event log controller and/or storage for managing and maintaining events, alerts, and notifications received by the controller 1410. For example, the controller 1410 or a system event log controller can receive alerts or notifications from one or more devices and components, and maintain the alerts or notifications in a system event log storage component.

Flash memory 1432 can be an electronic non-volatile computer storage medium or chip that can be used by the system 1400 for storage and/or data transfer. The flash memory 1432 can be electrically erased and/or reprogrammed. Flash memory 1432 can include EPROM (erasable programmable read-only memory), EEPROM (electrically erasable programmable read-only memory), ROM, NVRAM, or CMOS (complementary metal-oxide semiconductor), for example. The flash memory 1432 can store the firmware 1434 executed by the system 1400 when the system 1400 is first powered on, along with a set of configurations specified for the firmware 1434. The flash memory 1432 can also store configurations used by the firmware 1434.

The firmware 1434 can include a Basic Input/Output System or equivalents, such as an EFI (Extensible Firmware Interface) or UEFI (Unified Extensible Firmware Interface). The firmware 1434 can be loaded and executed as a sequence program each time the system 1400 is started. The firmware 1434 can recognize, initialize, and test hardware present in the system 1400 based on the set of configurations. The firmware 1434 can perform a self-test, such as a POST (Power-On-Self-Test), on the system 1400. This self-test can test the functionality of various hardware components such as hard disk drives, optical reading devices, cooling devices, memory modules, expansion cards, and the like. The firmware 1434 can address and allocate an area in the memory 1404, ROM 1406, RAM 1408, and/or storage device 1412, to store an operating system (OS). The firmware 1434 can load a boot loader and/or OS, and give control of the system 1400 to the OS.

The firmware 1434 of the system 1400 can include a firmware configuration that defines how the firmware 1434 controls various hardware components in the system 1400. The firmware configuration can determine the order in which the various hardware components in the system 1400 are started. The firmware 1434 can provide an interface, such as an UEFI, that allows a variety of different parameters to be set, which can be different from parameters in a firmware default configuration. For example, a user (e.g., an administrator) can use the firmware 1434 to specify clock and bus speeds, define what peripherals are attached to the system 1400, set monitoring of health (e.g., fan speeds and CPU temperature limits), and/or provide a variety of other parameters that affect overall performance and power usage of the system 1400. While firmware 1434 is illustrated as being stored in the flash memory 1432, one of ordinary skill in the art will readily recognize that the firmware 1434 can be stored in other memory components, such as memory 1404 or ROM 1406.

System 1400 can include one or more sensors 1426. The one or more sensors 1426 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 1426 can communicate with the processor, cache 1428, flash memory 1432, communications interface 1424, memory 1404, ROM 1406, RAM 1408, controller 1410, and storage device 1412, via the bus 1402, for example. The one or more sensors 1426 can also communicate with other components in the system via one or more different means, such as inter-integrated circuit (I2C), general purpose output (GPO), and the like. Different types of sensors (e.g., sensors 1426) on the system 1400 can also report to the controller 1410 on parameters, such as cooling fan speeds, power status, operating system (OS) status, hardware status, and so forth. A display 1436 may be used by the system 1400 to provide graphics related to the applications that are executed by the controller 1410.

FIG. 15 illustrates an example computer system 1500 having a chipset architecture that can be used in executing the described method(s) or operations, and generating and displaying a graphical user interface (GUI). Computer system 1500 can include computer hardware, software, and firmware that can be used to implement the disclosed technology. System 1500 can include a processor 1510, representative of a variety of physically and/or logically distinct resources capable of executing software, firmware, and hardware configured to perform identified computations. Processor 1510 can communicate with a chipset 1502 that can control input to and output from processor 1510. In this example, chipset 1502 outputs information to output device 1514, such as a display, and can read and write information to storage device 1516. The storage device 1516 can include magnetic media, and solid state media, for example. Chipset 1502 can also read data from and write data to RAM 1518. A bridge 1504 for interfacing with a variety of user interface components 1506, can be provided for interfacing with chipset 1502. User interface components 1506 can include a keyboard, a microphone, touch detection, and processing circuitry, and a pointing device, such as a mouse.

Chipset 1502 can also interface with one or more communication interfaces 1508 that can have different physical interfaces. Such communication interfaces can include interfaces for wired and wireless local area networks, for broadband wireless networks, and for personal area networks. Further, the machine can receive inputs from a user via user interface components 1506, and execute appropriate functions, such as browsing functions by interpreting these inputs using processor 1510.

Moreover, chipset 1502 can also communicate with firmware 1512, which can be executed by the computer system 1500 when powering on. The firmware 1512 can recognize, initialize, and test hardware present in the computer system 1500 based on a set of firmware configurations. The firmware 1512 can perform a self-test, such as a POST, on the system 1500. The self-test can test the functionality of the various hardware components 1502-1518. The firmware 1512 can address and allocate an area in the memory 1518 to store an OS. The firmware 1512 can load a boot loader and/or OS, and give control of the system 1500 to the OS. In some cases, the firmware 1512 can communicate with the hardware components 1502-1510 and 1514-1518. Here, the firmware 1512 can communicate with the hardware components 1502-1510 and 1514-1518 through the chipset 1502, and/or through one or more other components. In some cases, the firmware 1512 can communicate directly with the hardware components 1502-1510 and 1514-1518.

It can be appreciated that example systems 1400 (in FIGS. 14) and 1500 can have more than one processor (e.g., 1430, 1510), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A virtual desktop system comprising:
a plurality of available Cloud regions that each include resources for providing a virtual desktop to a client device of a user via a network;
a monitoring service coupled to the available cloud regions, the monitoring service operable to collect use data from the plurality of available cloud regions in relation to providing virtual desktops to other client devices;
a resource management engine coupled to the available cloud regions, the resource management engine operable to determine a score for each of a plurality of sets of the plurality of Cloud regions in relation to the client device; and
a control plane selecting a set of the plurality of Cloud regions from the plurality of sets according to the determined scores of each of the plurality of sets to provide the virtual desktop to the client device.

2. The system of claim 1 wherein the scores are determined on at least one of provider, location, carbon rating, predicted status, predicted capacity, predicted initial latency, subsequent latency, and cost.

3. The system of claim 1, wherein the control plane provisions all the Cloud regions of the selected set of Cloud regions to provide the virtual desktop.

4. The system of claim 3, wherein the control plane deactivates Cloud regions that do not belong to the selected set of Cloud regions.

5. The system of claim 3, wherein the control plane reevaluates scores of each of the Cloud regions of the plurality of the Cloud regions on determining a changed condition.

6. The system of claim 5, wherein the changed condition includes one of new Cloud regions are introduced, existing Cloud regions are deprecated, a change in a cost structure of a Cloud region, a significant new population of users, a significant change in user locations, and a change in technical capability of resources of one of the Cloud regions.

7. The system of claim 3, wherein the control plane reevaluates scores of the Cloud regions of the plurality of the Cloud regions periodically.

8. The system of claim 1, wherein at least one of the plurality of Cloud regions are inactive and wherein the determination of scores includes running a simulation for the inactive Cloud region.

9. The system of claim 8, wherein the simulation is run based on data from older connections between the user and the inactive Cloud region.

10. The system of claim 8, wherein the simulation is run based on other users with a similar profile to the user.

11. The system of claim 8, wherein the simulation is run based on synthetically generated data by agents over simulated networks using test accounts running benchmark tests against the inactive Cloud region.

13. The system of claim 1, wherein the scoring is based on values of a set of requirement dimensions.

14. The system of claim 13, further comprising weighting the values of the set of requirement dimensions.

15. The system of claim 13, wherein the weighting is based on predetermined rules.

16. The system of claim 15, wherein the predetermined rules include geographic diversity or Cloud provider diversity.

17. The system of claim 1, wherein the control plane determines the plurality of sets by reducing the number of total possible sets of the plurality of Cloud regions by eliminating certain of the total possible sets.

18. The system of claim 17, wherein the sets are excluded based on at least one of user resource requirements, lack of diversity of service, lack of contractual advantages, or lack of increasing the score of the region set.

19. A method for managing Cloud regions to provide a virtual desktop to a user operating a client device, the method comprising:
identifying a plurality of available Cloud regions that each include resources for providing a virtual desktop to a client device of a user via a network;
collecting use data from the plurality of available cloud regions in relation to providing virtual desktops to other client devices via a monitoring service coupled to the available cloud regions;
determining a score for each of a plurality of sets of the plurality of Cloud regions in relation to the client device; and
selecting a set of the plurality of Cloud regions from the plurality of sets according to the determined scores of each of the plurality of sets to provide the virtual desktop to the client device.

20. A non-transitory computer-readable medium having machine-readable instructions stored thereon, which when executed by a processor, cause the processor to:
identify a plurality of available Cloud regions that each include resources for providing a virtual desktop to a client device of a user via a network;
collect use data from the plurality of available cloud regions in relation to providing virtual desktops to other client devices via a monitoring service coupled to the available cloud regions;
determine a score for each of a plurality of sets of the plurality of Cloud regions in relation to the client device; and
select a set of the plurality of Cloud regions from the plurality of sets according to the determined scores of each of the plurality of sets to provide the virtual desktop to the client device.
